(19) United States
(12) Patent Application Publication
(10) Pub. No.: US 2015/0211932 A1
(43) Pub. Date: Jul. 30, 2015

(54) Method for Checking the Serviceability of Point Heaters of a Rail Network

(71) Applicant: SIEMENS AKTIENGESELLSCHAFT, Muenchen (DE)

(72) Inventors: Wolfgang Bachmann, Braunschweig (DE); Christian Bode, Braunschweig (DE); Hendrik Haskamp, Pohle (DE); Doris Martitz, Meine (DE); Karsten Rahn, Cremlingen (DE)

(21) Appl. No.: 14/422,575

(22) PCT Filed: Aug. 6, 2013
(86) PCT No.: PCT/EP2013/066467

§ 371 Date: Feb. 19, 2015

(30) Foreign Application Priority Data
Aug. 20, 2012 (DE) 10 2012 214 781.0

(51) Int. Cl. G01J 5/02; B61L 7/08

(52) U.S. Cl. CPC G01J 5/02; B61L 7/08

(57) ABSTRACT

A method for checking the serviceability of a heater of a set of switch points of a rail network includes determining the position of the switch points, detecting the thermal radiation emitted by the switch points, and transmitting the value of the measured thermal radiation and/or a value derived therefrom to a maintenance control center.

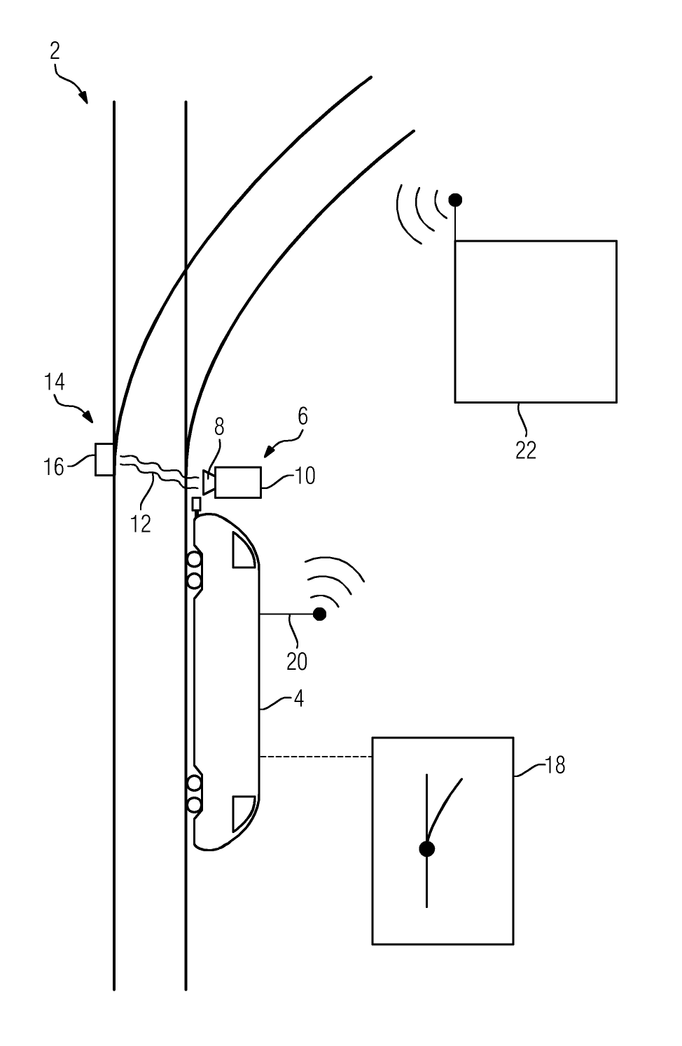

The invention relates to a method for checking the serviceability of point heaters of a rail network.

Rail vehicles are moved on lines also referred to as a track, comprising two mutually parallel steel rails. The two rails are spaced apart at a distance from each other that corresponds to the gauge of the rail vehicles used. In order to maintain the spacing the rails are fixed to sleepers of wood, concrete, steel or similar, which essentially extend transversely to the direction in which the rails are laid.

Points are provided in order to enable a change of a rail vehicle from one track to another track without interruption of the movement of the vehicle. In this case the two rails of a line, referred to below as stock rails, are split into two lines by the spacing between the same being increased. A V-shaped rail, the so-called core, is disposed between the two stock rails once the spacing between the stock rails corresponds to twice the gauge. Each free end of the core forms a separate line with the respective stock rail.

In the case of active points, two pivotable point blades are disposed in the region of the core. Depending on the setting of the points, one of the point blades contacts the stock rail associated therewith on the inside thereof, wherein said point blade essentially extends over the spacing of the gauge to the opposing stock rail. The remaining point blade is spaced apart from said stock rail. In order to enable a change of track, the two point blades are pivoted so that the respective one of the point blades contacts the associated stock rail and the other point blade is spaced apart from the stock rails.

At low temperatures there is the possibility that the point blades freeze solid onto the respective stock rails. This is encouraged in the presence of moisture. Conventionally, points are therefore heated by means of heating elements in the event of such weather. The heating elements are either implemented as electrical thermal resistors or as burners operated by gas or similar. In order to check the operation of the heating elements, the current flowing through the same or the gas throughput is measured. During this it cannot be determined for example whether the heating element has released from the points, and consequently the points are not operational.

It is an object of the invention to specify a particularly suitable method for checking the serviceability of a heating means of a set of points of a rail network. A further object of the invention is to specify a particularly suitable monitoring device for this purpose.

According to the invention, regarding the method the object is achieved by the features of claim 1 and regarding the monitoring device by the features of the independent claim 7. Advantageous developments and embodiments are the subject matter of the respective dependent claims.

The method is used for checking the serviceability of a heating means of a set of points of a rail network, by means of which the points are heated. In this context a set of points means in particular a track construction that enables rail vehicles to change from one line to another line without an interruption of travel. The lines, also referred to as a track, comprise two rails in this case that are retained by means of sleepers and that extend essentially parallel to each other apart from in the region of the points. The lines and points are referred to collectively as a rail network.

The points themselves comprise two stock rails and preferably two point blades that are pivotably disposed between the stock rails and that are attached to the points in the region of a core. In order to prevent the point blade or the point blades from freezing solid, the points heating means preferably comprises a heating element that is disposed in the region of the contact surface of the point blade on the stock rail. In particular, the points heating means comprises two heating elements, of which one is externally connected to the stock rail in the region of the contact surface on the stock rail in each case. Externally here refers to the side of the stock rail opposite the contact surface. Alternatively or in combination with this, a heating element of the points heating means is disposed in the region of the core.

The method provides that in one step the position of the points is determined and in a further step the thermal radiation emitted by the points is detected, wherein the two steps are carried out either sequentially or simultaneously. In particular, the detection of the thermal radiation takes place contactlessly. In this way the temperature of the points can be determined in the region of the contact point and in other regions of the points. Using the temperature value, a conclusion can be drawn regarding the serviceability of the points heating means and hence regarding any existing icing of the points.

In doing so it is not necessary to have recourse to any available auxiliary variables, such as for example the current necessary for operating the points heating means, by means of which a somewhat erroneous temperature of the points is calculated. Consequently, the diagnostic quality of the functional check is increased, especially as it is made possible to only measure the temperature in a region that is to be checked, preferably in the region of the contact point of the point blade on the stock rail.

The result of the functional check is suitably transmitted to a maintenance control center, which is part of a track control center for example. The result or the value of the operational check is either the value of the measured thermal radiation and/or a value derived therefrom in this case. This is binary for example, and in particular indicates whether the temperature of the points is above a defined temperature value that allows safe operation of the points. Because of the transmission of the value to the control center, which in particular takes place without delay, suitable measures can be taken to restore the operating safety of the points if the heating power of the points heating means is too low.

In particular, the transmission is carried out by radio. Because of the radio transmission, connecting the points to the central control station or to the control station by means of wiring is not necessary, which reduces the material complexity and the costs.

It is particularly preferred if the position of the points is determined by means of a track atlas. The term track atlas means a plan that is in particular in electronic form and that contains the position of individual components of the rail network. For example, the coordinates of the points are recorded in the track atlas and are compared with the coordinates at which the measurement of the thermal radiation is carried out. Said coordinates are determined for example by means of a GPS device or other systems for position determination.

For example, a temperature value of the points determined from the emitted thermal radiation is compared with an ambient temperature of the points. In particular, the difference between the two, or whether the difference exceeds a defined specified value, is used as a derived value that is transmitted to the maintenance control center. Using the comparison of the measured thermal radiation at the location of the points with the ambient temperature, it is possible to determine the serviceability of the points heating means, i.e. whether the points heating means is heating the points.

Advantageously, a setpoint value is determined, depending on which the detection of the thermal radiation is carried out. The setpoint value is for example a binary value, depending on which the points heating means is supplied with energy. The setpoint value thus specifies whether the heating means is activated or not. In other words, the thermal radiation of the points is only determined if the points heating means is operated. This is, for example, always the case if the ambient temperature is less than a predefined threshold value. Consequently, the binary setpoint value is set to a first value if the ambient temperature is above the threshold value and otherwise to a second value. Thus in particular the operation of the points heating means is assumed at an ambient temperature that is below the predefined threshold value. Alternatively, the setpoint value is advantageously interrogated at the maintenance control center.

It is particularly preferred if the value of the measured thermal radiation or the value derived therefrom is transmitted to the maintenance control center depending on the setpoint value. In this case the thermal radiation of the points is thus detected first and in a further step said value is compared with the setpoint value. For example, the setpoint value is a specific temperature value or a determined temperature range. This advantageously specifies an expected value for the temperature of the points. A transmission to the maintenance control center will take place only if the temperature value derived from the value of the measured thermal radiation is not within the temperature range, i.e. the thermal power of the points heating is not sufficient.

Alternatively, the setpoint value is also binary and specifies whether the points heating means is activated. Consequently, a transmission of the measured value in particular takes place if the points heating means is activated. Accordingly, in this case the derived value is transmitted that advantageously indicates whether the points heating is defective, i.e. the measured value of the thermal radiation is too low. In principle, a comparison with the setpoint value is also possible in the maintenance control center.

To carry out the method, a monitoring device is used that comprises a heat-sensitive sensor and analysis electronics coupled to the heat-sensitive sensor so as to enable signal communications. The heat-sensitive sensor is for example a pyroelectric sensor or particularly preferably a thermal imaging camera. For example, the monitoring device comprises a further sensor or a thermometer, by means of which the ambient temperature of the monitoring device, whose value is compared with the value measured by the heat-sensitive sensor, is determined. In particular, the monitoring device comprises a transmitting unit, with which the measured value for the temperature of the points can be transmitted.

Accordingly, the monitoring device is attached to a rail vehicle. This enables the serviceability of all point heaters to be checked on the way while the rail vehicle is travelling along the lines of the rail network. Thus only a comparatively small number of monitoring devices is required to ensure the serviceability of the point heaters of the rail network.

For example, prior to setting the route to work a maintenance train with such a monitoring device is moved along the lines and the serviceability of all points heating means is checked. However, it is also conceivable that during the operation of the rail network a certain train, for example each tenth train traversing the rail network, is fitted with such a monitoring device, and hence the serviceability of the point heaters is essentially continuously checked. In this way, on the one hand efficient monitoring of the points heating means is enabled and on the other hand costs are saved. Furthermore, it is possible that the values of the temperature of the points determined by means of the monitoring device are transmitted by means of any communications devices provided in the rail vehicle to the maintenance center, resulting in a cost saving.

Accordingly, the monitoring device is essentially operated continuously if the same is moving along the rail network.

The thermal radiation of the rail network is thus essentially detected continuously. A transmission of the value of the measured thermal radiation or of the value derived therefrom to the maintenance control center advantageously takes place if at least two conditions are fulfilled: The position of the monitoring device corresponds essentially to that of the points, and the points heating means is activated, which is determined in particular using the setpoint value. Alternatively, for this purpose the comparison with the setpoint value takes place in the maintenance control center following the completion of the transmission. If there should be an activated points heating means according to the setpoint value but the thermal radiation essentially corresponds to the ambient temperature of the points, defective points heating is identified.

An exemplary embodiment of the invention is described in detail below using a figure. The single figure shows schematically a method for checking the serviceability of a heating means of a set of points of a rail network.

A rail vehicle 4 to which a monitoring device 6 is connected is moved along the rail network 2. The monitoring device 6 comprises an IR camera 8, also referred to as a thermal imaging camera, and analysis electronics 10. Using the monitoring device 6, thermal radiation 12 is measured that is emitted by a set of points 14 in the region of a heating element of an activated, i.e. energized, points heating means 16. For this purpose, during the movement of the rail vehicle 4 its position is continuously determined and compared with a track atlas 18. The track atlas 18 contains the coordinates of the points 14 in electronic form and the position of the rail vehicle 4 is determined either by means of a GPS receiver or of another system for position determination.

Using the IR camera 8, the thermal radiation 12 of the points 14 is recorded and a temperature value is calculated by the analysis electronics 10. The temperature of the points 14 is thus measured contactlessly. In addition, an ambient temperature of the points 14 is detected using the monitoring device 6. For example, this takes place if the rail vehicle 4 is relatively far away from the points 14 or the thermal imaging camera 8 is tilted by means of a swivel mechanism away from a measurement direction oriented towards the points 14. From the temperature value of the points 14, the ambient temperature is derived and this result is compared with a binary setpoint value that indicates whether an activated points heating means 16 is present. The setpoint value is placed in a memory of the analysis electronics 10 and is stored there before the rail vehicle 4 journey starts. Alternatively, the setpoint value is transmitted for this purpose while the rail vehicle 4 is travelling, in particular continuously or event-driven as the rail vehicle 4 travels over the points 14.

If the thermal radiation 12 emitted by the points 14 is below a defined limit value, or the difference between the same and the ambient temperature is below a different defined limit value, and the setpoint value specifies an activated points heating means 16, a fault of the points heating means 16 is concluded. Consequently a derived value is produced that indicates the serviceability of the points heating means 16. Said value is transmitted by radio by means of a transmitting system 20 to a maintenance control center 22 of the rail network 2, by which suitable countermeasures are taken. The comparison between the ambient temperature, the limit values, the setpoint value and the temperature of the points 14 determined using the emitted thermal radiation 12 is carried out in this case either in the analysis electronics 10 of the rail vehicle 4 or in electronics in the maintenance control center 22.

Furthermore, if the ambient temperature is not different from the temperature of the points 14, whose position is known based on the track atlas 18 and whose temperature is determined using the emitted thermal radiation 12, a failed points heating means 16 is identified.

The invention is not limited to the exemplary embodiment described above. Rather, other versions of the invention can also be derived therefrom by a person skilled in the art without departing from the subject matter of the invention. In particular, all individual features described in connection with the exemplary embodiment can also be combined with each other in another way without departing from the subject matter of the invention.

### REFERENCE CHARACTER LIST

2 rail network
4 rail vehicle
6 monitoring device
8 IR camera
10 analysis electronics
12 thermal radiation
14 points
16 points heating
18 track atlas
20 transmitting system
22 maintenance control center

1-9. (canceled)

10. A method for checking the serviceability of a heater for a set of switch points of a rail network, the method comprising the following steps:
determining a position of the switch points;
detecting and measuring thermal radiation emitted by the switch points; and
transmitting at least one of a value of the measured thermal radiation or a value derived therefrom to a maintenance control center.

11. The method according to claim 10, which further comprises carrying out the step of transmitting the value of the measured thermal radiation or the derived value to the maintenance control center by radio.

12. The method according to claim 10, which further comprises carrying out the step of determining the position of the switch points by using a track atlas.

13. The method according to claim 10, which further comprises comparing the value of the measured thermal radiation to an ambient temperature.

14. The method according to claim 10, which further comprises using a difference between the value of the measured thermal radiation and the ambient temperature as a derived value.

15. The method according to claim 10, which further comprises determining a set point value, and carrying out the steps of detecting the thermal radiation or transmitting the value of the measured thermal radiation or the value derived therefrom in dependence on the set point value.

16. A monitoring device for checking the serviceability of a heater for a set of switch points of a rail network, the monitoring device comprising:
a heat-sensitive sensor; and
analysis electronics:
determining a position of the switch points;
detecting and measuring thermal radiation emitted by the switch points; and
transmitting at least one of a value of the measured thermal radiation or a value derived therefrom to a maintenance control center.

17. The monitoring device according to claim 16, wherein said heat-sensitive sensor is an IR camera.

18. The monitoring device according to claim 16, wherein the monitoring device is a mobile monitoring device.

19. A rail vehicle, comprising:
a monitoring device for checking the serviceability of a heater for a set of switch points of a rail network;
said monitoring device including a heat-sensitive sensor and analysis electronics;
said analysis electronics:
determining a position of the switch points,
detecting and measuring thermal radiation emitted by the switch points, and
transmitting at least one of a value of the measured thermal radiation or a value derived therefrom to a maintenance control center.
